(19) United States
(12) Patent Application Publication
(10) Pub. No.: US 2025/0053584 A1
(43) Pub. Date: Feb. 13, 2025

(54) METHOD OF PUSHING INFORMATION, COMPUTER DEVICE AND STORAGE MEDIUM

(71) Applicant: Beijing Zitiao Network Technology Co., Ltd., Beijing (CN)

(72) Inventors: Xinwei YU, Beijing (CN); Shixing JIN, Beijing (CN); Leiqi YAO, Beijing (CN); Zhengxing LI, Beijing (CN); Chen RAN, Beijing (CN); Fan XU, Beijing (CN); Mingxin HUANG, Beijing (CN); Aonan TAN, Beijing (CN)

(21) Appl. No.: 18/797,460

(22) Filed: Aug. 7, 2024

(30) Foreign Application Priority Data
Aug. 8, 2023 (CN) 202310996246.8

(51) Int. Cl. G06F 16/33; G06F 16/335; G06F 40/205

(52) U.S. Cl. CPC G06F 16/3334; G06F 16/335; G06F 40/205

(57) ABSTRACT

A method of pushing information, a computer device and a storage medium are provided. The method includes: acquiring a plurality of real-time multimedia contents corresponding to each broadcast subject of at least one broadcast subject, wherein the multimedia contents correspond to at least one of a plurality of genres; for each broadcast subject, generating text information corresponding to the each broadcast subject based on the multimedia contents corresponding to the each broadcast subject; inputting a constraint condition and the text information corresponding to the each broadcast subject into a content generation model to obtain a target broadcast content corresponding to the each broadcast subject; and in response to satisfying a push trigger condition of a target broadcast subject of the at least one broadcast subject, pushing a target broadcast content under the target broadcast subject to a target user.

### CROSS-REFERENCE TO RELATED APPLICATION

The present application claims priority of the Chinese Patent Application No. 202310996246.8, filed on Aug. 8, 2023, the disclosure of which is incorporated herein by reference in its entirety as part of the present application.

### TECHNICAL FIELD

The present disclosure relates to a method and apparatus of pushing information, a computer device, and a storage medium.

### BACKGROUND

With the rapid development of artificial intelligence technology, various kinds of artificial intelligence models are beginning to be widely used and play an increasingly important role in various fields. As an important application scenario of the artificial intelligence models, the artificial intelligence models can be used to match pushing information for a user in advance, and the pushing information is pushed to the user. However, the current method of pushing information has a problem that the use acquires the information in low efficiency.

### SUMMARY

Embodiments of the present disclosure provide at least one method and apparatus of pushing information, a computer device, and a storage medium.

The embodiments of the present disclosure provide a method of pushing information, which includes:
acquiring a plurality of real-time multimedia contents corresponding to each broadcast subject of at least one broadcast subject, wherein the multimedia contents correspond to at least one of a plurality of genres;
for each broadcast subject, generating text information corresponding to the each broadcast subject based on the multimedia contents corresponding to the each broadcast subject;
inputting a constraint condition and the text information corresponding to the each broadcast subject into a content generation model to obtain a target broadcast content corresponding to the each broadcast subject; and
in response to satisfying a push trigger condition of a target broadcast subject of the at least one broadcast subject, pushing a target broadcast content under the target broadcast subject to a target user.

In a possible implementation, the content generation model is trained by:
acquiring a content template corresponding to each broadcast subject of the at least one broadcast subject, wherein the content template includes: event contents organized in a preset format and respectively associated with a plurality of events corresponding to the each broadcast subject; and
generating the content generation model by using the content template to train a model to be trained.

In a possible implementation, acquiring the plurality of real-time multimedia contents corresponding to the each broadcast subject of at least one broadcast subject, includes:
for each broadcast subject, determining a target information source corresponding to the each broadcast subject, wherein a confidence degree corresponding to the target information source satisfies a preset confidence degree condition; and
acquiring the multimedia contents corresponding to the each broadcast subject and published by the target information source in real time.

In a possible implementation, generating the text information corresponding to the each broadcast subject based on the multimedia contents corresponding to the each broadcast subject, includes:
performing parse processing on the multimedia contents corresponding to the each broadcast subject to obtain candidate text information corresponding to the multimedia contents; and
filtering the text information corresponding to the each broadcast subject from the candidate text information.

In a possible implementation, filtering the text information corresponding to the each broadcast subject from the candidate text information, includes:
clustering the candidate text information to obtain candidate text information groups respectively corresponding to a plurality of events under the each broadcast subject; and
filtering a target text information group satisfying a target filtering condition from the candidate text information groups corresponding to the plurality of the events respectively, wherein the target text information group includes the text information corresponding to the each broadcast subject.

In a possible implementation, the method further includes:
storing candidate text information and vector data corresponding to the candidate text information into a vector database in association;
in response to acquiring questioning information sent by the target user after pushing the target broadcast content to the target user, filtering target text information associated with the questioning information from the vector database based on the questioning information and the vector data;
inputting the target text information into the content generation model to obtain an answer result associated with the questioning information; and
pushing the answer result to the target user.

In a possible implementation, the method further includes: pushing pieces of alternative questioning information to the target user; and
wherein acquiring the questioning information sent by the target user, includes:
in response to the target user triggering target candidate questioning information in the pieces of the alternative questioning information, determining the target alternative questioning information as the questioning information.

In a possible implementation, filtering target text information associated with the questioning information from the vector database based on the questioning information and the vector data, includes:
performing keyword extraction processing on the questioning information to obtain a query keyword corresponding to the questioning information; and
filtering the target text information associated with the questioning information from the vector database based on an association degree between a keyword vector corresponding to the query keyword and the vector data stored in the vector database.

In a possible implementation, the push trigger condition includes at least one selected from the group consisting of:
the target user subscribing to the broadcast content corresponding to the target broadcast subject;
receiving a push request sent by the target user corresponding to the target broadcast subject; and
a content display page corresponding to the target broadcast subject being opened.

The embodiments of the present disclosure provide an apparatus of pushing information, which includes an acquiring module, a generating module, a processing module, and a pushing module.

The acquiring module is configured to acquire a plurality of real-time multimedia contents corresponding to each broadcast subject of at least one broadcast subject, wherein the multimedia contents correspond to at least one of a plurality of genres.

The generating module is configured to, for the each broadcast subject, generate text information corresponding to the each broadcast subject based on the multimedia contents corresponding to the each broadcasting subject.

The processing module is configured to input a constraint condition and the text information corresponding to the each broadcast subject into a content generation model to obtain a target broadcast contents corresponding to the each broadcast subject.

The pushing module is configured to push a target broadcast content under the target broadcast subject to a target user in response to satisfying a push trigger condition of a target broadcast subject of the at least one broadcast subject.

In a possible implementation, the apparatus further includes a training module, which is configured to use the following steps to train the content generation model:
acquiring a content template corresponding to each broadcast subject of the at least one broadcast subject, wherein the content template includes: event contents organized in a preset format and respectively associated with a plurality of events corresponding to the each broadcast subject; and
generating the content generation model by using the content template to train a model to be trained.

In a possible implementation, when acquiring a plurality of real-time multimedia contents corresponding to each broadcast subject of at least one broadcast subject, the acquiring module is configured to:
for each broadcast subject, determine a target information source corresponding to the each broadcast subject, wherein a confidence degree corresponding to the target information source satisfies a preset confidence degree condition; and
acquire a multimedia content corresponding to the each broadcast subject and published by the target information source in real time.

In a possible implementation, when generating text information corresponding to the each broadcast subject based on the multimedia contents corresponding to the each broadcast subject, the generating module is configured to:
perform parse processing on the multimedia contents corresponding to each broadcast subject to obtain candidate text information corresponding to the multimedia contents; and
filter the text information corresponding to the each broadcast subject from the candidate text information.

In a possible implementation, when filtering the text information corresponding to the each broadcast subject from the candidate text information, the generating module is configured to:
cluster the candidate text information to obtain candidate text information groups respectively corresponding to a plurality of events under the each broadcast subject; and
filter a target text information group satisfying a target filtering condition from the candidate text information groups corresponding to the plurality of the events respectively, wherein the target text information group includes the text information corresponding to the each broadcast subject.

In a possible implementation, the apparatus further includes a storage module, which is configured to store candidate text information and vector data corresponding to the candidate text information into a vector database in association;
the acquiring module is further configured to, in response to acquiring questioning information sent by the target user after pushing the target broadcast content to the target user, filter target text information associated with the questioning information from the vector database based on the questioning information and the vector data;
the generating module is further configured to input the target text information into the content generation model to obtain an answer result associated with the questioning information; and
the pushing module is further configured to push the answer result to the target user.

In a possible implementation, the pushing module is further configured to push pieces of alternative questioning information to the target user; and
when acquiring the questioning information sent by the target user, the acquiring module is configured to, in response to the target user triggering target candidate questioning information in the pieces of the alternative questioning information, determine the target alternate questioning information as the questioning information.

In a possible implementation, when filtering target text information associated with the questioning information from the vector database based on the questioning information and the vector data, the acquiring module 31 is configured to perform keyword extraction processing on the questioning information to obtain a query keyword corresponding to the questioning information; and filter the target text information associated with the questioning information from the vector database based on the association degree between a keyword vector corresponding to the query keyword and the vector data stored in the vector database.

In a possible implementation, the push trigger condition includes at least one selected from the group consisting of:
the target user subscribing to the broadcast content corresponding to the target broadcast subject;
receiving a push request sent by the target user corresponding to the target broadcast subject; and
a content display page corresponding to the target broadcast subject being opened.

The embodiments of the present disclosure further provide a computer device, which includes at least one processor and a memory. The memory stores machine-readable instructions that are executable by the at least one processor, and the at least one processor is configured to execute the machine-readable instructions stored in the memory. When the machine-readable instructions are executed by the at least one processor, the at least one processor executes a method of pushing information in any possible implementation mentioned above.

The embodiments of the present disclosure further provide a non-transient computer-readable storage medium. Computer programs are stored on the non-transient computer-readable storage medium, and when the computer programs are run by a computer device, the computer device executes a method of pushing information in any possible implementation mentioned above.

For the description of the effect of the apparatus of pushing information, the computer device, and the non-transient computer-readable storage medium mentioned above, please refer to the description of the method of pushing information above-mentioned, which will not be repeated here.

It should be understood that the above general description and the detailed description following are only illustrative and explanatory and do not limit the technical solutions of the present disclosure.

In order to make the aforesaid purpose, features and advantages of the present disclosure more obvious and easier to understand, the following is a special example of the best embodiment, and together with the attached drawings, the following is described in detail.

### BRIEF DESCRIPTION OF DRAWINGS

In order to illustrate the technical solutions of the embodiments of the present disclosure more clearly, the drawings required to be used in the embodiments are briefly introduced below. The drawings are incorporated into the specification and form a part of the specification. The drawings show the embodiments that conform to the present disclosure and are used together with the specification to illustrate the technical solutions of the present disclosure. It should be understood that the following drawings only show some embodiments of the present disclosure, and therefore should not be regarded as limitations to the scope. Other related drawings can also be derived from these drawings by those ordinarily skilled in the art without creative efforts.

FIG. 1 illustrates a flow chart of a method of pushing information provided by some embodiments of the present disclosure;

FIG. 2a, FIG. 2b, FIG. 2c, and FIG. 2d illustrate specific examples of an information interaction page provided by some embodiments of the present disclosure;

FIG. 3 illustrates a schematic diagram of an apparatus of pushing information provided by some embodiments of the present disclosure; and

FIG. 4 illustrates a schematic diagram of a computer device provided by some embodiments of the present disclosure.

### DETAILED DESCRIPTION

In order to make the purposes, technical solutions and advantages of the embodiments of the present disclosure clearer, the technical solutions in the embodiments of the present disclosure will be clearly and completely described below in conjunction with the drawings in the embodiments of the present disclosure. Obviously, the described embodiments are only part of the embodiments of the present disclosure, instead of all the embodiments. The components of the embodiments of the present disclosure that are typically described and shown here, may be deployed, and designed in a variety of different configurations. Therefore, the following detailed description of the embodiments of the present disclosure is not intended to limit the claimed scope of the present disclosure, but merely represents the selected embodiments of the present disclosure. Based on the embodiments of the present disclosure, all other embodiments obtained by those ordinarily skilled in the art without creative efforts belong to the scope of protection of the present disclosure.

It is found that when an artificial intelligence model is used to match pushing information for a user, the corresponding pushing information is matched for the user based on the user's browsing habits for information. However, in fact, this pushing method is only applicable to the pushing of information that has already been formed, i.e., the information pushed to the user is always the information published by other users, such as media, social networking sites, online social public accounts. Such information is usually relatively one-sided, and when the user wants to know the more comprehensive real-time information in a certain field, the user needs to conduct a large amount of information search, which is not beneficial to the user's reading and leads to user acquiring information in low efficiency.

Based on the above research, the present disclosure provides a method of pushing information. On the basis of ensuring the timeliness of a broadcast content pushed to a user by using multimedia contents acquired in real-time, based on certain constraint conditions, a content generation model is used to integrate text information corresponding to a plurality of multimedia contents to obtain a target broadcast content, so that the target broadcast content can include more comprehensive information corresponding to a broadcast subject, which is convenient for the user to read and improves the efficiency of user acquiring information.

Defects existing in the above solutions derive from the practice and careful research of inventors. Therefore, the discovery process of the above-mentioned problems and the solutions to the above-mentioned problems proposed below by the present disclosure should be deemed as the contribution of the inventors to the present disclosure in the course of the present disclosure.

It should be noted that similar numerals and letters in the drawings below indicate similar items. Therefore, once an item is defined in a drawing, the item does not need to be further defined and explained in subsequent drawings.

It is understandable that before using the technical solutions disclosed in the embodiments of the present disclosure, the type, scope of use, and use scenarios of the personal information involved in the present disclosure shall be informed to the user and the authorization shall be obtained from the user through appropriate methods in accordance with relevant laws and regulations.

For example, when responding to an active request from a user, prompt information is sent to the user to explicitly prompt the user that the operation requested to be executed will need to acquire and use personal information of the user. Thus, according to the prompt information, the user can choose whether to provide the personal information to software or hardware such as an electronic device, an application, a server, or a storage medium that executes the operation of the technical solution of the present disclosure.

As an optional but non-limited implementation, in response to acquiring an active request from a user, the way of sending the prompt information to the user, for example, may be a way of the pop-up window, and the pop-up window may present the prompt information in a form of text. In addition, the pop-up window may also carry a selection control for the user to choose to “agree” or “disagree” to provide the personal information to the electronic device.

It is understandable that the above-mentioned notification and the process of acquiring the authorization of the user are only schematic, and do not limit the implementation of the present disclosure, and other methods that meet the relevant laws and regulations can also be applied to the implementation of the present disclosure.

In order to facilitate the understanding of the present embodiment, an method of pushing information disclosed in the embodiments of the present disclosure is described in detail firstly, and the executing body of the method of pushing information provided by the embodiments of the present disclosure is generally a computer device with certain computing capability, and the computer device includes, for example, a terminal device, a server or other processing device, and the terminal device may be a user equipment (UE), a mobile device, a user terminal, a terminal, a cellular phone, a cordless phone, a personal digital assistant (PDA), a handheld device, a computing device, a vehicle device, a wearable device, etc. In some possible implementations, the method of pushing information can be implemented by the processor calling computer-readable instructions stored a memory.

A method of pushing information provided by an embodiment of the present disclosure is described below.

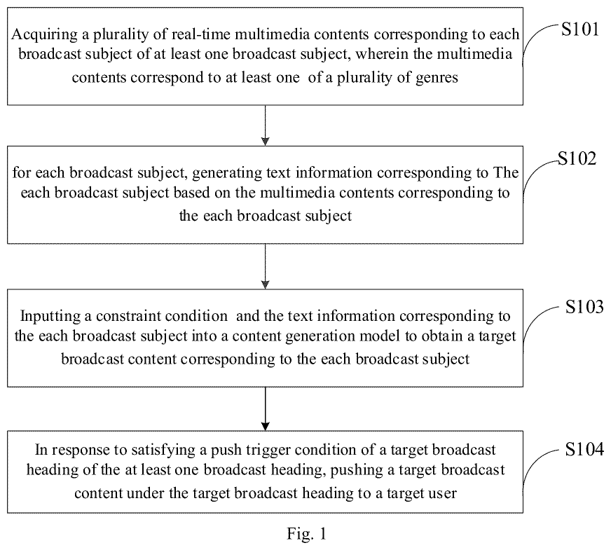

Referring to FIG. 1, which is a flow chart of a method of pushing information provided by the embodiment of the present disclosure, the method includes steps S101˜S104.

S101: acquiring a plurality of real-time multimedia contents corresponding to each of at least one broadcast subject, wherein the multimedia contents correspond to at least one of a plurality of genres.

In a specific implementation, the broadcast subject may include, for example, a subject that is preset and related to the information to be pushed to a user, for example, including: stock market, entertainment gossip, finance, real estate, tourism, etc. The specific broadcast subject can be set according to actual needs. The multimedia contents corresponding to the broadcast subject correspond to at least one genre of the plurality of genres. The plurality of genres may include, for example, at least one selected from the group consisting of text, images, videos, audios, etc.

Specifically, a plurality of real-time multimedia contents corresponding to each of the at least one broadcast subject may be acquired in the following ways:
for each broadcast subject of the at least one broadcast subject, determining a target information source corresponding to the each broadcast subject, wherein a confidence degree corresponding to the target information source satisfies a preset confidence degree condition; and
acquiring a multimedia content corresponding to the each broadcast subject and published by the target information source in real time.

Thus, the credibility of the information source is ensured, thereby enhancing the authenticity of the generated broadcast content.

The target information source, for example, may be at least one of the media, websites, and users who publish specific information in the websites in the relevant fields corresponding to the broadcast subject etc. The target information source, for example, may be determined by the following ways:
determining a plurality of candidate information sources corresponding to a broadcast subject, and acquiring relevant information corresponding to each candidate information source; determining the confidence degree of each candidate information source based on the relevant information corresponding to each candidate information source; and in response to the confidence degree of any candidate information source satisfying the preset confidence degree condition, determining the candidate information source as the target information source corresponding to the broadcast subject.

The relevant information includes, for example, information such as the relevance degree between the historical multimedia content published by the candidate information source and the broadcast content, and the accuracy of the historical multimedia content; the number of comments and the comment information made by other users on the historical multimedia content published by the candidate information source; the number of times that the historical multimedia content is cited by other users; and the authentication information corresponding to the candidate information source.

In a possible implementation, the greater the relevance degree between the broadcast subject and the historical multimedia content published by the candidate information source is and the higher the accuracy of the historical multimedia content is, then the higher the confidence degree corresponding to the candidate information source is. The richer the comment information made by other users on the historical multimedia content published by the candidate information source is, the more the number of comments is, and the more times the historical multimedia contents are cited by other users, then the higher the confidence degree corresponding to the candidate information source is. When the authentication information corresponding to the candidate information source is a veteran in the relevant field, or the official media in the corresponding field, then the confidence degree corresponding to the candidate information source is higher. Specifically, the confidence degrees of the candidate information sources can be determined comprehensively in a plurality of dimensions.

After determining the confidence degrees of the candidate information sources, for example, the confidence degrees can be compared to a preset confidence degree threshold. In response to a confidence degree being greater than the preset confidence degree threshold, the confidence degree of the candidate information source is considered to satisfy the preset confidence degree condition, and the candidate information source is determined as the target information source.

After determining the target information source corresponding to each broadcast subject, the relevant dynamics of the target information source can be monitored in real time. After detecting that a target information source has published a multimedia content, whether the multimedia content is related to the broadcast subject is determined. If the multimedia content is related to the broadcast subject, the multimedia content is determined to be the multimedia content corresponding to the broadcast subject.

Thus, by ensuring the reliability of the information published by the information source, the accuracy and reliability of the real-time multimedia content corresponding to the broadcast subject can be determined, and the problem in the target broadcast content pushed to the user is reduced.

Continuing to the above S101, the method of pushing information provided by the embodiments of the disclosure further include the step S102.

S102: for each broadcast subject, generating text information corresponding to the each broadcast subject based on the multimedia contents corresponding to the each broadcast subject.

In the specific implementation, after acquiring a plurality of real-time multimedia contents corresponding to the broadcast subject, for example, the text information corresponding to each broadcast subject may be generated in the following way:
performing parse processing on the multimedia contents corresponding to the each broadcast subject to obtain candidate text information corresponding to the multimedia contents; and
filtering the text information corresponding to the each broadcast subject from the candidate text information.

In the specific implementation, for the multimedia contents with different genres, based on the parse method associated with the corresponding genre, the text information corresponding to the broadcast subject can be generated based on the multimedia content.

In the case where the multimedia content includes an audio, for example, the first neural network model that converts audio information into text information can be used to process the audio, so that the multimedia content in the genre of audio is converted into corresponding text information.

In the case where the multimedia content includes an image, for example, a neural network model that processes images can be used to recognize objects included in the image, such as recognizing the type of the object in the image, recognizing the behavior and action of the object in the image; meanwhile, a preset text extraction method can also be used to extract the possible text from the images, and then the multimedia content in the genre of image is converted into the corresponding text information according to the recognition result of the object and/or the recognition result of the text.

In the case where the multimedia content includes a video (generally includes an audio and a plurality of video frame images), for example, a neural network model that processes videos can be used to process the video, recognize the text included in the audio and/or the video frame images of the video, and determine the specific events corresponding to the video, the objects associated with the video, etc., so as to convert the multimedia content in the genre of video into the corresponding text information.

In the case where the multimedia content includes text, the text can be directly used as text information, or the text can be further filtered to remove the parts that are irrelevant to the broadcast subject, so as to obtain the text information corresponding to the multimedia content in the genre of text.

After obtaining the candidate text information corresponding to the multimedia content, when the quantity of candidate text information determined is relatively small, such as a dozen or dozens of pieces of candidate text information, the content generating module can summarize the information carried in the candidate text information, and then all the candidate text information can be determined as the text information corresponding to the broadcast subject.

When the quantity of candidate text information is relatively large, such as obtaining thousands or even tens of thousands of pieces of candidate text information, it is difficult to display the information carried by all candidate text information to the user at one time. Therefore, the text information corresponding to each broadcast subject can be filtered from the candidate text information according to a certain filtering method.

Specifically, for example, the following method can be used to filter the text information corresponding to each broadcast subject from the candidate text information:
clustering the candidate text information to obtain candidate text information groups respectively corresponding to a plurality of events under the each broadcast subject; and
filtering a target text information group satisfying a target filtering condition from the candidate text information groups corresponding to the plurality of the events respectively, wherein the target text information group includes the text information corresponding to the each broadcast subject.

Specifically, when clustering the candidate text information, for example, keywords in each piece of candidate text information can be extracted and converted into corresponding keyword vectors. Then, based on the similarity between the keyword vectors respectively corresponding to different candidate text information, pieces of candidate text information are clustered. In addition, the candidate text information can also be converted into text vectors corresponding to the candidate text information, and the similarity between the text vectors corresponding to different candidate text information can be used to cluster the pieces of the candidate text information.

The aim of clustering includes dividing pieces of text information describing the same event into a category. Then, for each event, the text information associated with an event can be used to generate related content corresponding to the event, and the related content is served as a content that is used to describe the specific situation of the corresponding event under the title associated with the event.

For example, the target filtering condition may include at least one selected from the group consisting of:
the quantity of candidate text information included in the candidate text information group being greater than a preset quantity; and
the popularity value of the event associated with the candidate text information group being greater than a preset popularity value threshold.

Specifically, other target filtering conditions may also be set, which will not be limited by the embodiments of the present disclosure.

Continuing to the above-mentioned step S102, the method of pushing information provided by the embodiments of the disclosure further includes the step S103.

S103: inputting a constraint condition and the text information corresponding to the each broadcast subject into a content generation model to obtain a target broadcast content corresponding to the each broadcast subject.

In a specific implementation, the content generation model may be, for example, a neural network model that analyzes, integrates, and summarizes at least one piece of text information. The neural network model can use the text information to generate the broadcast contents satisfying the constraint conditions according to the input constraint conditions.

Here, the constraint condition, for example, may include at least one selected from the group consisting of a1, a2 and a3.
a1: preset information describing the content characteristic of the broadcast content, such as the organizational style of the broadcast content, the form of language description, etc.
a2: information limiting the broadcast content. For example, the generated broadcast content needs to follow the opinions and facts of the original text information, have high readability, and smooth description, and have no logical problems in the description.
a3: format information that describes the format of the broadcast content.

Other constraint conditions may also be set according to actual needs, which will not be limited by the embodiments of the present disclosure.

In addition, the embodiments of the present disclosure further provide a specific method of training the content generation model, which includes:
acquiring a content template corresponding to each broadcast subject of the at least one broadcast subject, wherein the content template includes: event contents organized in a preset format and respectively associated with a plurality of events corresponding to the each broadcast subject; and generating the content generation model by using the content template to train a model to be trained.

Thus, the content generation template can be used to rapidly generate the broadcast content organized according to the format indicated by the content template.

In a specific implementation, the content template, for example, includes the broadcast content obtained by serving the constraint conditions corresponding to the broadcast subject as the constraint, and summarizing the text information corresponding to a plurality of sample multimedia contents. Here, the method of acquiring the sample multimedia contents, for example, can be similar to the method of acquiring the above-mentioned multimedia contents, which will not be repeated here.

The process of generating a content template based on the plurality of the sample multimedia contents may include: for example, manually summarizing information in the sample multimedia contents to obtain the information recorded in the content template; and then organizing the information according to a preset format to obtain the content template.

In a possible implementation, a preset format corresponding to the content template, for example, can be preset according to actual needs. For example, at least two levels of titles can be set, and the at least two of titles are organized in a tree structure. The N-level title near the root node of the tree structure is set to an unchangeable title (N is an integer greater than 0), i.e., all the broadcast content generated under the corresponding broadcast subject will include the above titles to distinguish the type of information. In a level under the unchangeable title, a changeable title can be set. The specific title information can be modified according to the specific situation of the information carried in the text.

For example, “stocks” is illustrated as a broadcast subject, the titles corresponding to the information categories of the content template corresponding to the broadcast subject, for example, include four categories, “A-Share Trend”, “Expert Comments”, “Big V's Market Outlook” and “Institution's Market Outlook”. For example, under the titles corresponding to each information category, at least one level of sub-titles or sub-tags is included. For example, under the category of “A-Share Trend”, there are two sub-tags, “Broad Market Index” and “Sector Rises and Falls”, which respectively correspond to the information belonging to different sub-tags. The above-mentioned three titles cannot be changed. However, under the category of “Expert Comments”, there are sub-tags corresponding to a plurality of experts, and the sub-tags are Expert 1, Expert 2, Expert 3, Expert 4, and Expert 5, respectively. The title “Expert Comments” cannot be changed, but the Expert 1˜Expert 5 can be adjusted according to the source of the multimedia content actually acquired.

For example, a specific content template includes:
Welcome to today's stock market AI broadcast, I will provide you with a review of the A-share trend on Thursday, Jun. 29, 2023. You can talk to me to learn more about today's stock market.
#**A-Share Trend**
   **Broad Market Index**: for the A-share market today, the three major indexes all perform narrow-range fluctuations throughout the day. At the close, the Shanghai Composite Index fell by 0.22%, the Shenzhen Component Index fell by 0.1%, the Beijing Stock Exchange 50 rose by 0.72%, and the ChiNext Index fell by 0.09%. The full-day turnover of the Shanghai and Shenzhen stock markets reached XXXX billion yuan, and the northbound funds were net sold XXXX billion yuan. More than XXXX shares rose in both markets.
   **Sector Rises and Falls**: for the sector, rare earth permanent magnets, consumer electronics and communication devices performed strong momentum, the game sector and the media sector rebounded, and the air transportation sector and the liquor sector fell. The concept of reducers performed strong momentum, the game sector and the media sector rose first, the consumer electronics sector rose, and the power sector fell. XX Communication Group, XX Precision Instrument Manufacturing Company, and XX Interactive Entertainment Company received net inflows, while XX Information Company, XX Group, and XX Liquor were sold off.
#**Expert Comments**
   **@ Expert 1**: The turnover of the A-share market is low today . . . it is recommended to “Buy with conviction, then let time do its work”.
   **@ Expert 2**: The market index did not fall significantly, but the individual stocks showed severe divergence . . . with a strongly spillover effect.
   **@ Expert 3**: . . .
   **@ Expert 4**: . . .
   **@ Expert 5**: The A-share market today displayed a state of still waters with slight ripples, as the Shanghai Composite Index had minor fluctuations . . . when selecting stocks, priority should be given to stock quality with a deep dive into fundamental analysis. The valuation of the Hong Kong stocks is better than that of the A-shares market, and there is potential for significant improvement once the liquidity conditions enhance.
#**Big V's Market Outlook
   **@ Big V1*: The market shrinks and fluctuates, and the market loses its backbone after AI adjustment . . . . Food and beverage companies present opportunities in the medium to long term, but they lack market attention in the short term.
   **@ Big V2**: The A-share market falls, but yet sectors such as robotics-related stocks are still rising . . . . The broader market is still very dangerous.
   **@BigV3**: . . .
   *@BigV4**: . . .
   **@BigV5**: Despite the A-share market has encountered turbulence, . . . can hold on, there will be good results in the later stage of the market.
#**Institution's Market Outlook
   **@Institution 1**: Various macro-indicators show that the economic recovery momentum is weakening . . . . It is expected that the stock index will primarily trend upwards with fluctuations in the future.
   **@Institution 2**: . . .
   **@Institution 3**: . . .
   **@Institution 4**: The market environment in the second half of the year for . . . sector allocation may focus on the direction of technology growth, construction insurance, and semiconductor resources.

In another possible embodiment, the unchangeable title can also be not set, but the corresponding text contents can be categorized according to events associated with the acquired multimedia contents, and event information corresponding to the events is determined for each category. The event information corresponding to the events is used as the title, and then the specific event content corresponding to the events is displayed under the corresponding title.

For example, an example in which “Morning News” is the broadcast subject is illustrated, the events corresponding to the broadcast subject are sorted from highest to lowest in order of popularity, and respectively include: Event 1, Event 2, . . . , Event n. Each time, the relevant information corresponding to up to 5 of the most popular events will be recommended to users as the broadcast content. Then the generated content template includes:

Welcome to Morning News AI Broadcast, I will provide you with the highlights of 5 hot news events on **Week X, Day XX Month X, Year XXXX**. You can talk to me to learn more details of today's news events.
#**Event 1**
   **@XX Flash News**: Country X intends to extradite XXX, the founder of the “XX” Group, but the spokesperson XXX for the XX Department of Country Y stated that Country X will not extradite its own citizens to other countries. A spokesperson for Country X stated that Country ZZ is not among the countries with which country X has an extradition treaty.
   **@XX Network**: . . .
   **@TT Network**: . . .
   **@Big V1**: Comparing the former staff XXX of X to . . . , and the impact was controlled in time.
#**Event 2**
   **@XX Network Technology**: A number of colleges and universities issued announcements to suspend the use of XX payment . . . preferential policies, starting from Day X Month X.
   **@XX Official Account** . . .
   **@Home of XX**: A number of colleges and universities stated that they would switch to using XX cards, XX and other channels.
   **@Official Insight News**: The XX payment team stated that the intention behind this adjustment was to . . . assist students and parents in using the XX Payment more conveniently.
#**Event 3**
   **@XX Agency**: It has been reported that XX started using a ventilator for treatment because of sleep apnea symptoms, which was confirmed by XX. The health state of XX has once again drawn the attention of the media.
   **@XX.com**: There is a message pointing out . . .
   **@XX Web**: CPAP machines reduce snoring by allowing users to keep their airways open while sleeping. It is acknowledged that . . . in XX Medical Report.
#**Event 4**
   **@XX Jingwei**: XX Research Institute, a subsidiary of XX Organization, will announce that XXX may be potentially carcinogenic to humans in Month X this year.
   **@XX News**: XXX has been researched several times, and an observational study in Country X, with respect to 100,000 adults, showed that . . . .
#**Event 5**
   **@XX News**: The Affiliated Hospital of XX University School of Medicine stated that online rumors . . . and has reported it to the local police station.
   **@XX News**: Online rumors that Doctor XX . . . legal action will be taken to pursue relevant responsibilities.

It should be noted here that the “ . . . ” in the above content templates are the omitted parts of the relevant information, which is just to facilitate the description of the form of the content template. In practice, when the content template is used to train the content generation model, the relevant parts are not omitted. The above-mentioned content template can also have other preset formats, i.e., after using the content generation model to summarize the text information, the corresponding content template can be formed after organizing according to the rule and method indicated by a certain format.

After generating the content template corresponding to the broadcast subject, the template can be used as supervision data, and the sample text information converted from the sample multimedia contents corresponding to the content template is used as input data to train the model to be trained and generate a content generation model.

In addition, when training the content generation model, the constraint condition corresponding to the broadcast subject will also be used as input data to be input into the model to be trained, so that the constraint condition and sample text information are used as training samples and the corresponding content template is used as supervision data, to train the model to be trained to obtain the content generation model.

When generating the target broadcast content corresponding to the broadcast subject, the constraint conditions and text information corresponding to the broadcast subject can be input into the content generation model to obtain the target broadcast content corresponding to each broadcast subject.

Continuing to the above-mentioned step S103, the method of pushing information provided by the embodiments of the present disclosure further includes the step S104.

S104: in response to satisfying a push trigger condition of a target broadcast subject of the at least one broadcast subject, pushing a target broadcast content under the target broadcast subject to a target user.

In a specific implementation, the push trigger condition includes, for example, at least one selected from the group consisting of b1, b2 and b3.

b1: the target user having subscribed to the broadcast content corresponding to the target broadcast subject.

Specifically, when the target user has subscribed to the broadcast content corresponding to the target broadcast subject, for example, the target broadcast content of the target broadcast subject to which the target user subscribes can be periodically pushed to the target user.

For example, the period includes: 24 hours, 12 hours, 3 hours, etc.

In any pushing period, when a user enters a specific content display page of the broadcast content for the first time in the pushing period, the target broadcast content is pushed to the user. For example, the content display page includes the homepage of an application program.

In addition, in the case where the target broadcast content is received by default, when the user has not entered the specific display page of the broadcast content, a prompt message can also be sent to the user. When the prompt message is triggered by the user, the content display page is displayed on the screen of the terminal device, and the target broadcast content is displayed on the content display page.

b2: receiving a push request sent by the target user corresponding to the target broadcast subject.

Here, for example, when entering a content display page, the user can actively send a push request for viewing a target broadcast subject to an artificial intelligence entity through the content display page.

After receiving the push request, the latest target broadcast content corresponding to the target broadcast subject is pushed to the user.

Here, the artificial intelligence entity is a computation entity based on artificial intelligence technology. The artificial intelligence entity can carry a content generation model and can generate the corresponding target broadcast content according to the received text information and the constraint condition by using the content generation model.

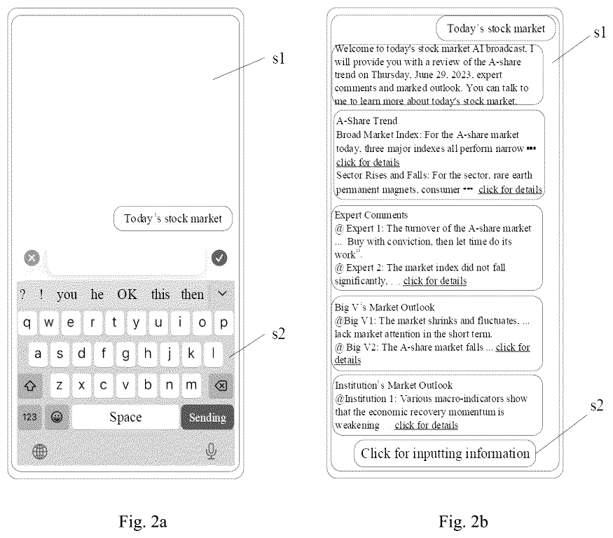

As shown in a of FIG. 2, which illustrates a specific example of a content display page, for example, the content display page may include a broadcast content display area s1 and an information inputting control s2. For example, the information inputting control s2 may include a virtual keyboard and a sending control. Through the information inputting control s2, the user can input information related to the push request and send the information to the artificial intelligence entity. After receiving the information related to the push request, the artificial intelligence entity confirms receiving t the push request corresponding to the target broadcast subject and pushes the target broadcast content under the target broadcast subject to the target user. In this example, the information corresponding to the push request includes, for example, “Today's stock market”.

As shown b of FIG. 2, b of FIG. 2 illustrates that, after the target user sends “Today's stock market” to the artificial intelligence entity, the artificial intelligence entity pushes the target broadcast content corresponding to the stock market to the target user, the terminal device corresponding to the target user displays the target broadcast content through a content display page.

In the example, due to the large content amount of the target broadcast content, the target broadcast content is divided into different titles, and the titles are displayed in the abbreviated form respectively. The information displayed includes a control for viewing the detailed information under the corresponding title, and when the control is clicked, the corresponding content is fully displayed in an information interaction page.

b3: a content display page corresponding to the target broadcast subject being opened.

Specifically, corresponding content display pages can be set for different broadcast subjects. After a content display page is opened, the corresponding target broadcast content is automatically pushed to a user.

In a method of pushing information provided by another embodiment of the present disclosure, the method further includes: storing candidate text information and vector data corresponding to the candidate text information into a vector database in association;
in response to acquiring questioning information sent by the target user after pushing the target broadcast content to the target user, filtering target text information associated with the questioning information from the vector database based on the questioning information and the vector data;
inputting the target text information into the content generation model to obtain an answer result associated with the questioning information; and
pushing the answer result to the target user.

In a specific implementation, the vector data corresponding to the candidate text information, for example, includes the keyword vector corresponding to at least one keyword obtained by extracting after performing keyword extraction processing on the candidate text information. In addition, the whole candidate text information can also be converted into vectors to obtain text vectors. The vector data can characterize the semantic characteristics of the candidate text information. Then, the candidate text information and the corresponding vector data are stored in the vector database in association.

After pushing the target broadcast content to the target user, the target user can input the corresponding questioning information in the information display page. For example, the questioning information is associated with the broadcast subject. The questioning information is then sent to the artificial intelligence entity. After receiving the questioning information, the artificial intelligence entity can perform keyword extraction processing on the questioning information to obtain query keywords corresponding to the questioning information. Based on an association degree between the keyword vector corresponding to the query keyword and the vector data stored in the vector database, the target text information associated with the questioning information is filtered from the vector database.

Then, the target text information obtained by filtering is input into the content generation model to obtain the answer result associated with the questioning information.

Here, when the content generation model generates the answer result, a constraint condition can also be determined for the content generation model. The constraint condition may be the same as the above-mentioned constraint condition corresponding to the broadcast subject, or may be different from it, which can be set specifically according to actual needs and will not be limited by the present disclosure.

In addition, in another embodiment of the present disclosure, pieces of alternative questioning information may also be pushed to the target user; when acquiring the questioning information sent by the target user, in response to the target user triggering target candidate questioning information in the pieces of the alternative questioning information, the target alternate questioning information can be determined as the questioning information.

In the example shown in c of FIG. 2, after displaying the target broadcast content corresponding to the broadcast subject “stock market” on the content display page for the user, the user inputs a new piece of questioning information “How is the new energy market today” through the information inputting control s2 set on the content display page.

In the example shown d of FIG. 2, after displaying the target broadcast content corresponding to the broadcast subject “stock market” on the content display page for the user, the content display page further displays the pieces of alternative questioning information for the user, including “Will the market fall again”, “How is new energy market today”, “Is AI games suitable for increasing positions”, and “A-shares take a plunge, what do experts say”. The user can click on any piece of alternative questioning information and trigger the piece of alternative questioning information to be sent to the artificial intelligence entity as the questioning information.

In the embodiments of the present disclosure, by acquiring the plurality of real-time multimedia contents corresponding to at least one broadcast subject, text information corresponding to the broadcast subject is generated based on the multimedia contents, then the text information and a constraint condition corresponding to the broadcast subject are input into a content generation model to obtain a target broadcast content corresponding to the broadcast subject, and a target broadcast content is pushed to a target user when a push trigger condition is satisfied. Thus, on the basis of ensuring the timeliness of a broadcast content pushed to the user by using multimedia contents acquired in real-time, based on a certain constraint condition, a content generation model is used to integrate text information corresponding to the plurality of multimedia contents to obtain the target broadcast content, so that the target broadcast content can include more comprehensive information corresponding to the broadcast subject, which is convenient for the user to read and improves the efficiency of user acquiring information.

Those skilled in the art may understand that in the above-mentioned method of the specific embodiment, the writing order of each step does not imply a strict order of execution but constitutes any limitation on the implementation process, and the specific order of execution of each step shall be determined by its function and possible internal logic.

Based on the same conception, the embodiments of the present disclosure also provides an apparatus of pushing information corresponding to the method of pushing information, and because the principle of the apparatus solving the problem in the embodiments of the present disclosure is similar to the above-mentioned method of pushing information in the embodiments of the present disclosure, the implementation of the apparatus can refer to the implementation of the method, and the repetition will not be repeated.

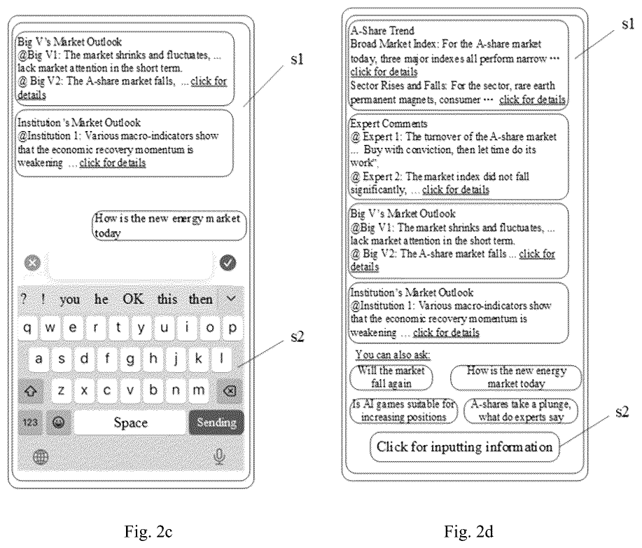

Referring to FIG. 3, which is a schematic diagram of an apparatus of pushing information provided by an embodiment of the present disclosure, the apparatus includes an acquiring module 31, a generating module 32, a processing module 33 and a pushing module 34.

The acquiring module 31 is configured to acquire a plurality of real-time multimedia contents corresponding to each broadcast subject of at least one broadcast subject, wherein the multimedia contents correspond to at least one of a plurality of genres.

The generating module 32 is configured to, for the each broadcast subject, generate text information corresponding to the each broadcast subject based on the multimedia contents corresponding to the each broadcasting subject.

The processing module 33 is configured to input a constraint condition and the text information corresponding to the each broadcast subject into a content generation model to obtain a target broadcast contents corresponding to the each broadcast subject.

The pushing module 34 is configured to push a target broadcast content under the target broadcast subject to a target user in response to satisfying a push trigger condition of a target broadcast subject of the at least one broadcast subject.

In a possible implementation, the apparatus further includes a training module 35, which is configured to use the following steps to train the content generation model:
acquiring a content template corresponding to each broadcast subject of the at least one broadcast subject, wherein the content template includes: event contents organized in a preset format and respectively associated with a plurality of events corresponding to the each broadcast subject; and
generating the content generation model by using the content template to train a model to be trained.

In a possible implementation, when acquiring a plurality of real-time multimedia contents corresponding to each broadcast subject of at least one broadcast subject, the acquiring module 31 is configured to:
for each broadcast subject, determine a target information source corresponding to the each broadcast subject, wherein a confidence degree corresponding to the target information source satisfies a preset confidence degree condition; and
acquire a multimedia content corresponding to the each broadcast subject and published by the target information source in real time.

In a possible implementation, when generating text information corresponding to the each broadcast subject based on the multimedia contents corresponding to the each broadcast subject, the generating module 32 is configured to:
perform parse processing on the multimedia contents corresponding to each broadcast subject to obtain candidate text information corresponding to the multimedia contents; and
filter the text information corresponding to the each broadcast subject from the candidate text information.

In a possible implementation, when filtering the text information corresponding to the each broadcast subject from the candidate text information, the generating module 32 is configured to:
cluster the candidate text information to obtain candidate text information groups respectively corresponding to a plurality of events under the each broadcast subject; and
filter a target text information group satisfying a target filtering condition from the candidate text information groups corresponding to the plurality of the events respectively, wherein the target text information group includes the text information corresponding to the each broadcast subject.

In a possible implementation, the apparatus further includes a storage module 36, which is configured to store candidate text information and vector data corresponding to the candidate text information into a vector database in association;
the acquiring module 31 is further configured to, in response to acquiring questioning information sent by the target user after pushing the target broadcast content to the target user, filter target text information associated with the questioning information from the vector database based on the questioning information and the vector data;
the generating module 32 is further configured to input the target text information into the content generation model to obtain an answer result associated with the questioning information; and
the pushing module 34 is further configured to push the answer result to the target user.

In a possible implementation, the pushing module 34 is further configured to push pieces of alternative questioning information to the target user; and
when acquiring the questioning information sent by the target user, the acquiring module 31 is configured to, in response to the target user triggering target candidate questioning information in the pieces of the alternative questioning information, determine the target alternate questioning information as the questioning information.

In a possible implementation, when filtering target text information associated with the questioning information from the vector database based on the questioning information and the vector data, the acquiring module 31 is configured to perform keyword extraction processing on the questioning information to obtain a query keyword corresponding to the questioning information; and filter the target text information associated with the questioning information from the vector database based on the association degree between a keyword vector corresponding to the query keyword and the vector data stored in the vector database.

In a possible implementation, the push trigger condition includes at least one selected from the group consisting of:
the target user subscribing to the broadcast content corresponding to the target broadcast subject;
receiving a push request sent by the target user corresponding to the target broadcast subject; and
a content display page corresponding to the target broadcast subject being opened.

The description of the processing flow of modules in the apparatus and the interaction flow between the modules can refer to the relevant description in the above-mentioned embodiments of the method, which will not be described in detail here.

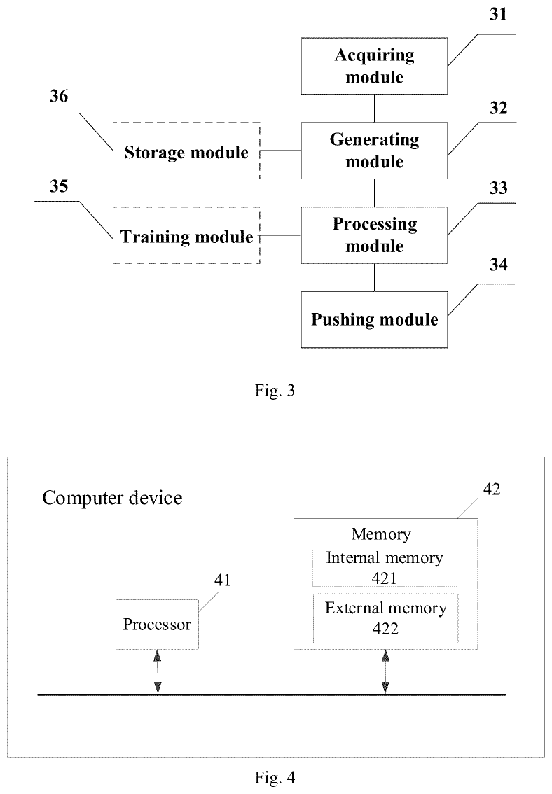

The embodiments of the present disclosure further provide a computer device, as shown in FIG. 4, which is a structural schematic diagram of a computer device provided by an embodiment of the present disclosure, the computer device includes at least one processor 41 and a memory 42.

The memory 42 stores machine-readable instructions that are executable by the at least one processor 41, the at least one processor 41 is used to execute the machine-readable instructions stored in the memory 42. When the machine-readable instructions are executed by the at least one processor 41, the at least one processor 41 executes the following steps:
acquiring a plurality of real-time multimedia contents corresponding to each broadcast subject of at least one broadcast subject, wherein the multimedia contents correspond to at least one of a plurality of genres;
for each broadcast subject, generating text information corresponding to the each broadcast subject based on the multimedia contents corresponding to each of the at least one broadcast subject;
inputting constraint conditions corresponding to the each broadcast subject and the text information into a content generation model to obtain target broadcast contents corresponding to the each broadcast subject; and
in response to satisfying a push trigger condition of a target broadcast subject of the at least one broadcast subject, pushing a target broadcast content under the target broadcast subject to a target user.

The memory 42 includes an internal memory 421 and an external memory 422. The memory 421 here is also called the internal storage, which is used to temporarily store the operation data in the processor 41 and the data exchanged with the external memory 422 such as a hard disk. The processor 41 exchanges data with the external memory 422 through the memory 421.

The specific execution process of the above-mentioned instructions can refer to the steps of the method of pushing information described in the embodiments of the present disclosure, which will not be repeated here.

The embodiments of the present disclosure further provide a non-transient computer-readable storage medium. Computer programs are stored on the non-transient computer-readable storage medium, and when the computer programs are run by a computer device, the computer device executes the method of pushing information described in the above-mentioned method embodiments. The storage medium can be a volatile or non-volatile computer-readable storage medium.

The embodiments of the present disclosure further provide a computer program product, the computer program product carries program codes, and the program codes includes instructions that can be used to execute the method of pushing information described in the above-mentioned method embodiments, which can be referred to the above-mentioned method embodiments specifically and will not be repeated herein.

The computer program product may be implemented in hardware, software, or a combination thereof. In an optional embodiment, the computer program product is specifically embodied as a computer storage medium, and in another optional embodiment, the computer program product is specifically embodied in a software product, such as a software development kit (SDK), etc.

Those skilled in the art can clearly understand that, for the convenience and conciseness of the description, the specific working process of the apparatus described above may refer to the corresponding process in the aforesaid method embodiments, which will not be repeated herein. In some embodiments provided by the present disclosure, it should be understood that the apparatus and method disclosed can be implemented by other means. The apparatus embodiments described above are only schematic, for example, the division of the units is only a logical function division, and there may be another division method when the apparatus is actually implemented, and for example, a plurality of units or components can be combined, or some features can be ignored or not executed. On the other hand, the coupling or direct coupling or communication connection between each other shown or discussed may be indirect coupling or communication connection through some communication interfaces, apparatuses, or units, which may be in electrical, mechanical, or other form.

The unit described as a separate component may be or may not be physically separated, and the component displayed as a unit may be or may not be a physical unit, i.e., may be located in a place, or may also be distributed on a plurality of network units. Some or all of the units can be selected according to actual needs to implement the purpose of the present embodiment solution.

In addition, the functional units in the embodiments of the present disclosure may be integrated in a processing unit, or each unit may exist separately physically, or two or more than two units may be integrated in a unit.

If the described function is implemented in the form of a software functional unit and marketed or used as an independent product, the function may be stored in a non-volatile computer-readable storage medium that can be executed by a processor. Based on this understanding, the technical solution of the present disclosure in essence or the part that contributes to the prior art or the part of the technical solution may be embodied in the form of a software product, and the computer software product is stored in a storage medium that includes several instructions for enabling a computer device (which may be a personal computer, a server, or a network device, etc.) to execute all or part of the steps of the method described in the embodiments of the present disclosure. The aforementioned storage medium includes various media that can store program codes, such as a USB flash drive, a mobile hard disk, a Read-Only Memory (ROM), a Random Access Memory (RAM), a disk, an optical disc, etc.

Finally, it should be noted that the above-mentioned embodiments are only specific embodiments of the present disclosure, which are used to illustrate the technical solutions of the present disclosure and not to limit them, and the scope of protection of the present disclosure is not limited to this. Although the present disclosure is described in detail with reference to the aforesaid embodiments, a person skilled in the art should understand that any person skilled in the art who is familiar with the art can still modify the technical solutions described in the aforesaid embodiments or can easily think of changes within the scope of the technology disclosed in the disclosure, or the equivalent substitution of some of the technical features. These modifications, changes or substitutions do not depart the essence of the corresponding technical solutions from the spirit and scope of the technical solutions of the embodiments of the present disclosure, which shall be covered in the scope of protection of the present disclosure. Therefore, the scope of protection of the present disclosure shall be in accordance with the scope of protection of the claims.

The invention claimed is:

1. A method of pushing information, comprising:
acquiring a plurality of real-time multimedia contents corresponding to each broadcast subject of at least one broadcast subject, wherein the multimedia contents correspond to at least one of a plurality of genres;
for each broadcast subject, generating text information corresponding to the each broadcast subject based on the multimedia contents corresponding to the each broadcast subject;
inputting a constraint condition and the text information corresponding to the each broadcast subject into a content generation model to obtain a target broadcast content corresponding to the each broadcast subject; and
in response to satisfying a push trigger condition of a target broadcast subject of the at least one broadcast subject, pushing a target broadcast content under the target broadcast subject to a target user.

2. The method of claim 1, wherein the content generation model is trained by:
acquiring a content template corresponding to each broadcast subject of the at least one broadcast subject, wherein the content template comprises: event contents organized in a preset format and respectively associated with a plurality of events corresponding to the each broadcast subject; and
generating the content generation model by using the content template to train a model to be trained.

3. The method of claim 1, wherein the acquiring a plurality of real-time multimedia contents corresponding to each broadcast subject of at least one broadcast subject, comprises:
for each broadcast subject, determining a target information source corresponding to the each broadcast subject, wherein a confidence degree corresponding to the target information source satisfies a preset confidence degree condition; and
acquiring the multimedia contents corresponding to the each broadcast subject and published by the target information source in real time.

4. The method of claim 1, wherein the generating text information corresponding to the each broadcast subject based on the multimedia contents corresponding to the each broadcast subject, comprises:
performing parse processing on the multimedia contents corresponding to the each broadcast subject to obtain candidate text information corresponding to the multimedia contents; and
filtering the text information corresponding to the each broadcast subject from the candidate text information.

5. The method of claim 4, wherein the filtering the text information corresponding to the each broadcast subject from the candidate text information, comprises:
clustering the candidate text information to obtain candidate text information groups respectively corresponding to a plurality of events under the each broadcast subject; and
filtering a target text information group satisfying a target filtering condition from the candidate text information groups corresponding to the plurality of the events respectively, wherein the target text information group comprises the text information corresponding to the each broadcast subject.

6. The method of claim 1, further comprising:
storing candidate text information and vector data corresponding to the candidate text information, in association, into a vector database;
in response to acquiring questioning information sent by the target user after pushing the target broadcast content to the target user, filtering target text information associated with the questioning information from the vector database based on the questioning information and the vector data;
inputting the target text information into the content generation model to obtain an answer result associated with the questioning information; and
pushing the answer result to the target user.

7. The method of claim 6, further comprising:
pushing pieces of alternative questioning information to the target user; and
wherein the acquiring the questioning information sent by the target user, comprises:
in response to the target user triggering target candidate questioning information in the pieces of the alternative questioning information, determining the target alternative questioning information as the questioning information.

8. The method of claim 6, wherein the filtering target text information associated with the questioning information from the vector database based on the questioning information and the vector data, comprises:
performing keyword extraction processing on the questioning information to obtain a query keyword corresponding to the questioning information; and
filtering the target text information associated with the questioning information from the vector database based on an association degree between a keyword vector corresponding to the query keyword and the vector data stored in the vector database.

9. The method of claim 1, wherein the push trigger condition comprises at least one selected from the group consisting of:
the target user subscribing to the broadcast content corresponding to the target broadcast subject;
receiving a push request sent by the target user corresponding to the target broadcast subject; and
a content display page corresponding to the target broadcast subject being opened.

10. The method of claim 2, wherein the generating text information corresponding to the each broadcast subject based on the multimedia contents corresponding to the each broadcast subject, comprises:
performing parse processing on the multimedia contents corresponding to the each broadcast subject to obtain candidate text information corresponding to the multimedia contents; and
filtering the text information corresponding to the each broadcast subject from the candidate text information.

11. The method of claim 3, wherein the generating text information corresponding to the each broadcast subject based on the multimedia contents corresponding to the each broadcast subject, comprises:
performing parse processing on the multimedia contents corresponding to the each broadcast subject to obtain candidate text information corresponding to the multimedia contents; and
filtering the text information corresponding to the each broadcast subject from the candidate text information.

12. A computer device, comprising:
at least one processor; and
at least one memory;
wherein the memory stores machine-readable instructions that are executable by the at least one processor, the at least one processor is configured to execute the machine-readable instructions stored in the memory, and when the machine-readable instructions are executed by the at least one processor, the at least one processor executes a method of pushing information, and the method of pushing information comprises:
acquiring a plurality of real-time multimedia contents corresponding to each broadcast subject of at least one broadcast subject, wherein the multimedia contents correspond to at least one of a plurality of genres;
for each broadcast subject, generating text information corresponding to the each broadcast subject based on the multimedia contents corresponding to the each broadcast subject;
inputting a constraint condition and the text information corresponding to the each broadcast subject into a content generation model to obtain a target broadcast content corresponding to the each broadcast subject; and
in response to satisfying a push trigger condition of a target broadcast subject of the at least one broadcast subject, pushing a target broadcast content under the target broadcast subject to a target user.

13. The computer apparatus of claim 12, wherein the content generation model is trained by:
acquiring a content template corresponding to each broadcast subject of the at least one broadcast subject, wherein the content template comprises: event contents organized in a preset format and respectively associated with a plurality of events corresponding to the each broadcast subject; and
generating the content generation model by using the content template to train a model to be trained.

14. The computer device of claim 12, wherein the acquiring a plurality of real-time multimedia contents corresponding to each broadcast subject of at least one broadcast subject, comprises:
for each broadcast subject, determining a target information source corresponding to the each broadcast subject, wherein a confidence degree corresponding to the target information source satisfies a preset confidence degree condition; and
acquiring the multimedia contents corresponding to the each broadcast subject and published by the target information source in real time.

15. The computer device of claim 12, wherein the generating text information corresponding to the each broadcast subject based on the multimedia contents corresponding to the each broadcast subject, comprises:
performing parse processing on the multimedia contents corresponding to the each broadcast subject to obtain candidate text information corresponding to the multimedia contents; and
filtering the text information corresponding to the each broadcast subject from the candidate text information.

16. The computer device of claim 15, wherein the filtering the text information corresponding to the each broadcast subject from the candidate text information, comprises:
clustering the candidate text information to obtain candidate text information groups respectively corresponding to a plurality of events under the each broadcast subject; and
filtering a target text information group satisfying a target filtering condition from the candidate text information groups corresponding to the plurality of the events respectively, wherein the target text information group comprises the text information corresponding to the each broadcast subject.

17. A non-transient computer-readable storage medium, wherein computer programs are stored on the non-transient computer-readable storage medium, and when the computer programs are run by a computer device, the computer device executes a method of pushing information, and the method of pushing information comprises:
acquiring a plurality of real-time multimedia contents corresponding to each broadcast subject of at least one broadcast subject, wherein the multimedia contents correspond to at least one of a plurality of genres;
for each broadcast subject, generating text information corresponding to the each broadcast subject based on the multimedia contents corresponding to the each broadcast subject;
inputting a constraint condition and the text information corresponding to the each broadcast subject into a content generation model to obtain a target broadcast content corresponding to the each broadcast subject; and
in response to satisfying a push trigger condition of a target broadcast subject of the at least one broadcast subject, pushing a target broadcast content under the target broadcast subject to a target user.

18. The non-transient computer-readable storage medium of claim 17, wherein the content generation model is trained by:
acquiring a content template corresponding to each broadcast subject of the at least one broadcast subject, wherein the content template comprises: event contents organized in a preset format and respectively associated with a plurality of events corresponding to the each broadcast subject; and
generating the content generation model by using the content template to train a model to be trained.

19. The non-transient computer-readable storage medium of claim 17, wherein the acquiring a plurality of real-time multimedia contents corresponding to the each broadcast subject of at least one broadcast subject, comprises:
for each broadcast subject, determining a target information source corresponding to the each broadcast subject, wherein a confidence degree corresponding to the target information source satisfies a preset confidence degree condition; and
acquiring the multimedia contents corresponding to the each broadcast subject and published by the target information source in real time.

20. The non-transient computer-readable storage medium of claim 17, wherein the generating text information corresponding to the each broadcast subject based on the multimedia contents corresponding to the each broadcast subject, comprises:
performing parse processing on the multimedia contents corresponding to the each broadcast subject to obtain candidate text information corresponding to the multimedia contents; and
filtering the text information corresponding to the each broadcast subject from the candidate text information.
